(19) United States
(12) Patent Application Publication
(10) Pub. No.: US 2015/0062300 A1
(43) Pub. Date: Mar. 5, 2015

(54) Wormhole Structure Digital Characterization and Stimulation

(71) Applicant: Halliburton Energy Services, Inc., Houston, TX (US)

(72) Inventors: Weiming Li, Katy, TX (US); Dandan Hu, Houston, TX (US)

(73) Assignee: Halliburton Energy Services, Inc., Houston, TX (US)

(21) Appl. No.: 14/015,888

(22) Filed: Aug. 30, 2013

(51) Int. Cl. H04N 7/18; H04N 13/02

(52) U.S. Cl. CPC H04N 7/183; H04N 13/0203
USPC 348/46; 348/61

(57) ABSTRACT

The present disclosure relates to digitally characterizing and simulating wormhole structures in rock. One example method includes receiving internal imaging data of a core sample of a rock formation; generating, by one or more processors of a computing system, a digital core sample model of the structure of the core sample based on the internal imaging data; and analyzing, by the one or more processors, the core sample model to determine the porosity value of the core sample.

### BACKGROUND

This specification relates to digitally characterizing and simulating wormhole structures in rock.

In oil and gas exploration, acid and stimulation treatments may be used to increase the conductivity of a rock formation by introducing conductive flow channels into the formation structure. Various parameters associated with the acid treatments may be varied to produce different flow channel structures, including the injection volume and velocity of the acid treatment fluid, and the characteristics of the acid used. Properties of the formation, such as porosity and permeability, may also affect the flow channels produced by a given acid treatment.

### DESCRIPTION OF DRAWINGS

FIG. 1A is a diagram of an example well system; FIG. 1B is a diagram of the example computing subsystem 110 of FIG. 1A.

FIG. 2A is a set of image slices produced by imaging a core sample; FIG. 2B is a three-dimensional model constructed from the set of image slices; FIG. 2C is a representation of the computer analysis performed to identify voids in the core sample from the three-dimensional model.

FIG. 3 is a representation of examples of different treatment profiles.

FIG. 4 is a three-dimensional model of a core sample including a wormhole structure.

FIG. 5 is a flow chart illustrating an example method for digitally characterizing and simulating wormhole structures in rock.

Like reference symbols in the various drawings indicate like elements.

### DETAILED DESCRIPTION

The present disclosure describes characterizing rock microstructure, including wormhole structure and stimulation efficiency, using internal imaging techniques (e.g., computerized tomography (CT) scanning, focused ion beam-scanning electron microscopy (FIB-SEM) and/or others).

In acidizing for carbonate formation, the success of stimulation treatments may depend at least in part on the production of highly conductive wormholes. Such wormholes can penetrate beyond a damaged zone in the rock, grow deep in the formation, and result in a negative skin. Obtaining such a wormhole may depend on the type of acid used in the treatment, the volume and pumping rate of the acid into formation, and the microstructure of the rock in the formation. Accordingly, the concepts herein include identifying rock microstructure from high resolution, non-destructive internal imaging techniques. Such analysis can reveal details of the porous media structure at micro to nano scale. The reconstructed three-dimensional (3D) micro and nano structures from the high resolution imaging can be used to improve the understanding of the physical properties of the rock. Important parameters to characterize rock structure such as porosity and permeability can also be calculated from high resolution images of the rock samples. Such information may allow the parameters of an acid treatment to be selected with greater precision, and may possibly lead to more efficient treatments and cost savings.

The concepts herein encompass performing digital analysis of core samples. In one example implementation, a core sample of a rock is imaged to produce a digital core sample model of the structure of the core sample. The core sample model is then analyzed to determine the porosity value of the core sample. In some cases, imaging the core sample is performed using a three-dimensional imaging technique, such as, for example, focused ion beam-scanning electron microscopy (FIB-SEM), computerized tomography (CT), nuclear magnetic resonance (NMR), and/or another imaging technique. The core sample model may be further analyzed to determine the permeability value of the core sample. Such analysis may include performing a computerized flow simulation using the core sample mode. A treatment to perform on the rock may (e.g., an acid or fracture treatment) be determined based at least in part on the core sample model.

In some cases, after performing a treatment on the rock, an additional core sample may be imaged to produce an additional core sample model. This core sample model may then be analyzed to determine the results of the treatment (e.g., the effectiveness, acid treatment profile, etc.). A field development plan may then be updated based on the results of the treatment.

By predicting optimized wormhole conditions, the cost of repeating numerous acid core flow tests may be reduced. The volume of acid spent during such tests may also be reduced, thereby further reducing cost. Reservoir recovery may also be increased for greater wormhole stimulation efficiency. The approach may also provide increased prediction accuracy for rock properties and enhanced understanding of dynamic formation process during acid stimulation.

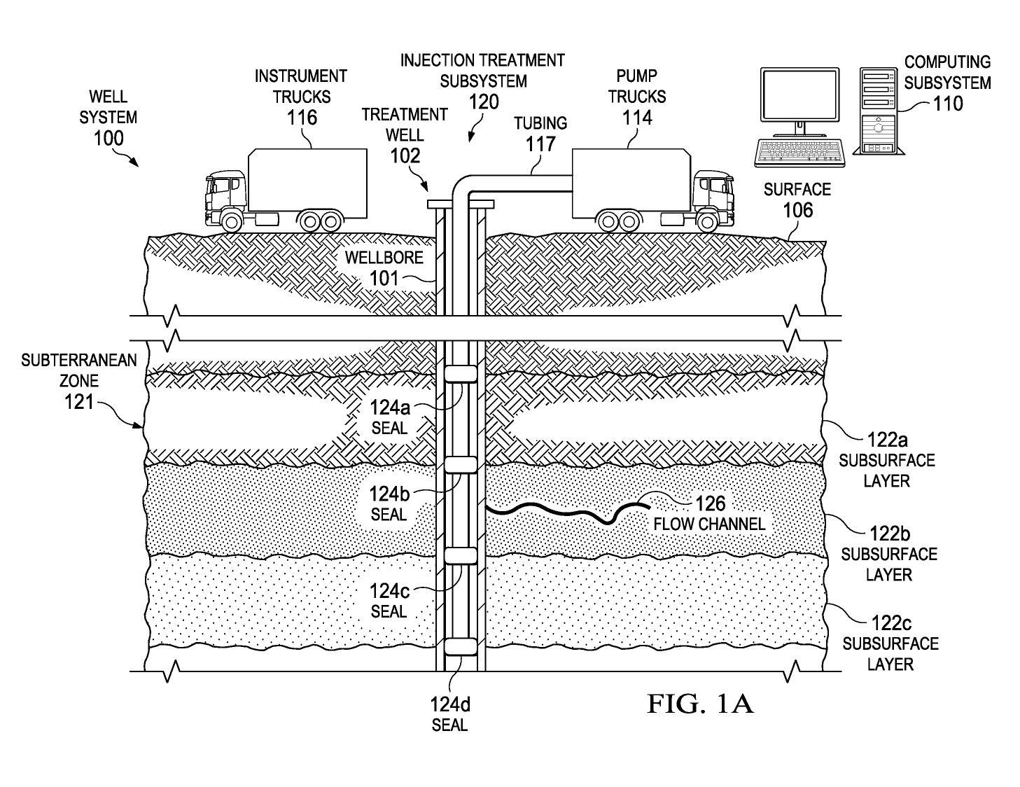

FIG. 1A shows a schematic diagram of an example well system 100. The example well system 100 includes a treatment well 102. The well system 100 can include one or more additional treatment wells, observation wells, or other types of wells. The computing subsystem 110 can include one or more computing devices or systems located at the treatment well 102, or in other locations. A computing subsystem 110 or any of its components can be located apart from the other components shown in FIG. 1A. For example, the computing subsystem 110 can be located at a data processing center, a computing facility, or another location. The well system 100 can include additional or different features, and the features of the well system can be arranged as shown in FIG. 1A or in any other configuration.

The example treatment well 102 includes a well bore 101 in a subterranean zone 121 of interest beneath the surface 106. The subterranean zone 121 can include one or fewer than one rock formation, or the subterranean zone 121 can include more than one rock formation. In the example shown in FIG. 1A, the subterranean zone 121 includes multiple subsurface layers 122a-c. The subsurface layers 122a-c can be defined by geological or other properties of the subterranean zone 121. For example, each of the subsurface layers 122a-c can correspond to a particular lithology, a particular fluid content, a particular stress or pressure profile, and/or another characteristic. In some instances, one or more of the subsurface layers 122a-c can be a fluid reservoir that contains hydrocarbons or other types of fluids. The subterranean zone 121 may include any rock formation. For example, one or more of the subsurface layers 122a-c can include sandstone, carbonate materials, shale, coal, mudstone, granite, or other materials.

The example treatment well 102 includes an injection treatment subsystem 120, which includes instrument trucks 116, pump trucks 114, and other equipment. The injection treatment subsystem 120 can apply an injection treatment to the subterranean zone 121 through the well bore 101. In certain instances, the injection treatment is an acid treatment configured to produce flow channels (e.g., 126) within the subterranean zone 121.

As shown, a tubing 117 may be inserted into the well bore 101. The tubing 117 includes one or more seals 124a-d. In some implementations, the seals 124a-d may include any structure operable to prevent passage of fluid into portions of the wellbore below the structure, including, but not limited to, mechanical set packers, tension set packers, rotation set packers, hydraulic set packers, inflatable rubber or balloon packers, swell packers, permanent packers, cement packers, and/or any other type of seal.

The seal 124a-b may be operable to divide the wellbore 101 into different zones while the acid treatment is being performed. For example, seal 124b may be activated to prevent the injected fluid from passing into portions of the wellbore 101 below the seal 124b (e.g., subsurface layers 122b and 122c). The seal 124a may also be closed to trap the injected fluid between the seal 124a and the seal 124b. By holding the fluid at pressure between these two seals 124a and 124b, the acid treatment may be performed on subsurface layer 122a.

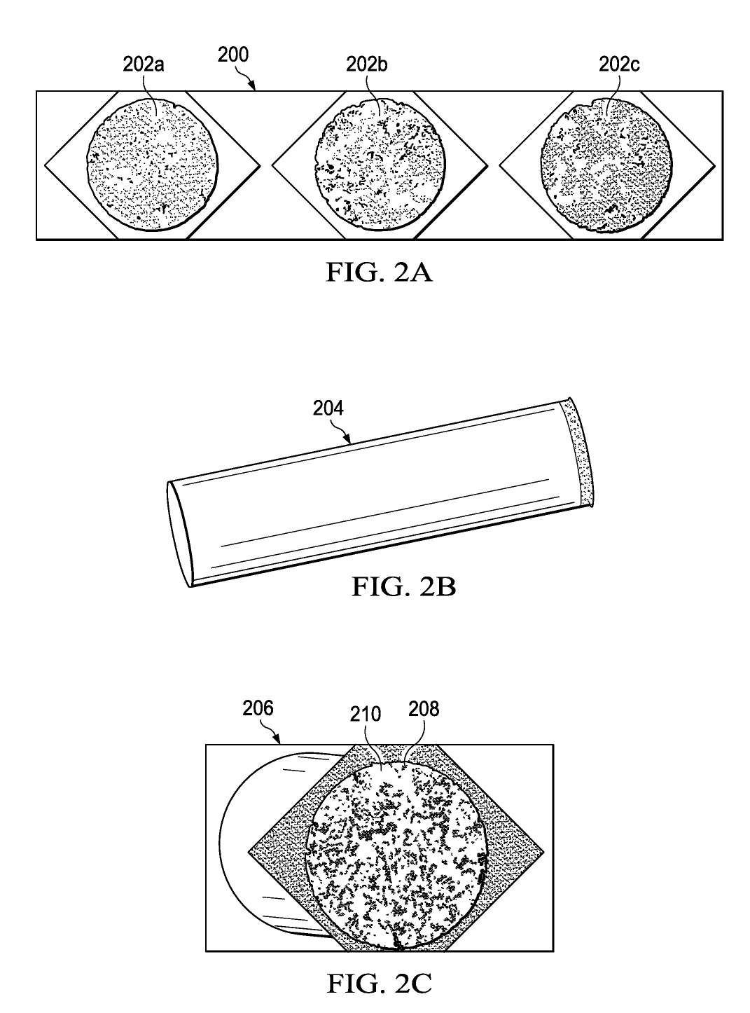

The acid treatment can generate flow channels in the subterranean zone 121, such as flow channel 126. Although flow channel 126 is shown as a single wormhole structure extending from the wall of the well bore 101, the acid treatment can generate different configurations of flow channels, including, but not limited to, uniform, ramified, conical, face, or any other configuration. Examples of these configurations are shown in FIG. 3.

In some implementations, the computing system 110 may be operable to analyze core samples taken from the subterranean zone 121. In some cases, the computing system 110 may be located at a drill site containing the well bore 101. The computer system 110 may also be located a remote site from the well bore 101. Core samples may be taken from within or around the wellbore 101, or from other core wells extending into the subterranean zone 121 (not shown). In some cases, the core samples may be taken from a subsurface layer that has already had an acid treatment applied to it (e.g., 122b) in order to determine the effectiveness of the acid treatment. Such a core sample may be analyzed by the computing subsystem 110 according to the techniques described herein.

Some of the techniques and operations described herein may be implemented by a computing subsystem configured to provide the functionality described. In various embodiments, a computing device may include any of various types of devices, including, but not limited to, personal computer systems, desktop computers, laptops, notebooks, mainframe computer systems, handheld computers, workstations, tablets, application servers, storage devices, or any type of computing or electronic device.

FIG. 1B is a diagram of the example computing subsystem 110 of FIG. 1A. The example computing subsystem 110 can be located at or near one or more wells of the well system 100 or at a remote location. All or part of the computing subsystem 110 may operate independent of the well system 100 or independent of any of the other components shown in FIG. 1A. The example computing subsystem 110 includes a processor 160, a memory 150, and input/output controllers 170 communicably coupled by a bus 165. The memory can include, for example, a random access memory (RAM), a storage device (e.g., a writable read-only memory (ROM) or others), a hard disk, or another type of storage medium. The computing subsystem 110 can be preprogrammed or it can be programmed (and reprogrammed) by loading a program from another source (e.g., from a CD-ROM, from another computer device through a data network, or in another manner). The input/output controller 170 is coupled to input/output devices (e.g., a monitor 175, a mouse, a keyboard, or other input/output devices) and to a communication link 180. The input/output devices receive and transmit data in analog or digital form over communication links such as a serial link, a wireless link (e.g., infrared, radio frequency, or others), a parallel link, or another type of link.

The communication link 180 can include any type of communication channel, connector, data communication network, or other link. For example, the communication link 180 can include a wireless or a wired network, a Local Area Network (LAN), a Wide Area Network (WAN), a private network, a public network (such as the Internet), a WiFi network, a network that includes a satellite link, or another type of data communication network. In some implementations, imaging data related to core samples taken from the well system 100 may be received at the computing subsystem 110 via the communication link 180. In some cases, the computing subsystem 110 may include an imaging device (not shown) operable to produce an electronic image of core samples provided from the well system 100.

The memory 150 can store instructions (e.g., computer code) associated with an operating system, computer applications, and other resources. The memory 150 can also store application data and data objects that can be interpreted by one or more applications or virtual machines running on the computing subsystem 110. As shown in FIG. 1B, the example memory 150 includes data 151 and applications 156.

In some implementations, the data 151 stored in the memory 150 may include core model data produced by the computing system analyzing core samples taken from the subterranean zone 121 shown in FIG. 1A. Such core model data may include three-dimensional models of the structure of the core samples. In some implementations, the three-dimensional models may be solid models. The three-dimensional models may also be represented any format.

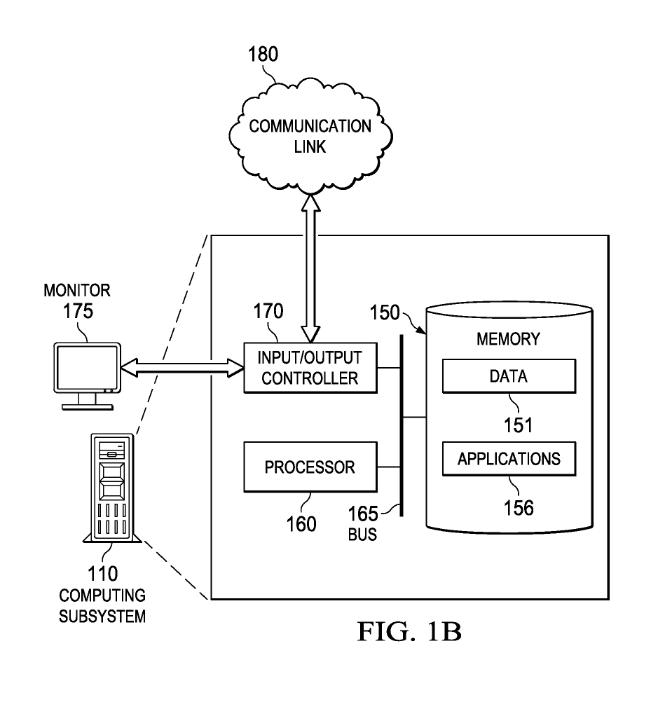

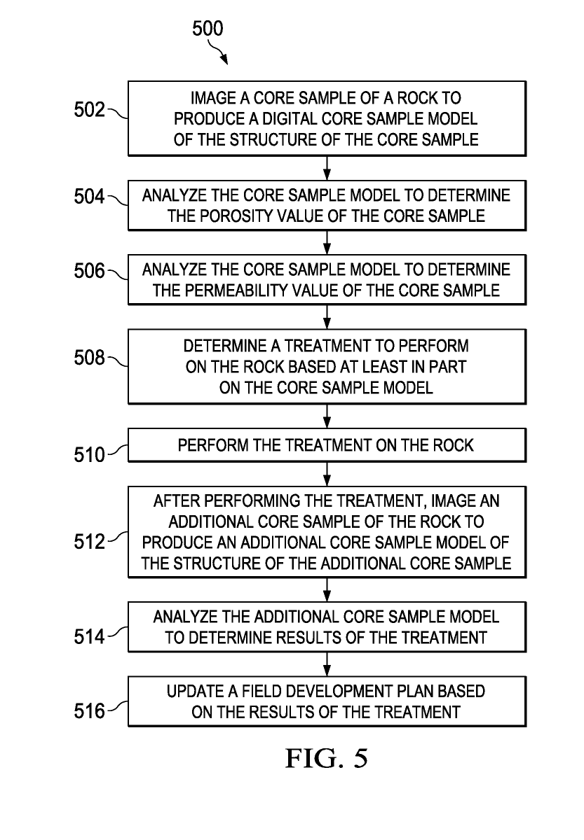

The applications 156 can include software applications, scripts, programs, functions, executables, or other modules that are interpreted or executed by the processor 160. Such applications may include machine-readable instructions for performing one or more of the operations represented in FIG. 5. The applications 156 may include machine-readable instructions for imaging and analyzing a core sample to produce a core sample model, as shown in and described in detail relative to FIGS. 2A-2C. The applications 156 can obtain input data from the memory 150, from another local source, or from one or more remote sources (e.g., via the communication link 180). The applications 156 can generate output data and store the output data in the memory 150, in another local medium, or in one or more remote devices (e.g., by sending the output data via the communication link 180).

The processor 160 can execute instructions, for example, to generate output data based on data inputs. For example, the processor 160 can run the applications 156 by executing or interpreting the software, scripts, programs, functions, executables, or other modules contained in the applications 156. The processor 160 may perform one or more of the operations represented in FIG. 5 or analyze a core sample to produce a core sample model, as shown in FIGS. 2A-2C. The input data received by the processor 160 or the output data generated by the processor 160 can include any of the data 151.

FIG. 2A is a set of image slices 200 produced by imaging a core sample taken from a subterranean zone, such as subterranean zone 121 shown in FIG. 1A. The set 200 includes one or more image slices 202a-c. Each of the one or more image slices 202a-c represents a cross-section of the core sample taken at a certain position. The image slices 202a-c may be produced by a non-destructive imaging technique, such that the core sample is not destroyed and remains intact after the imaging process. The image slices 202a-c may be produced by any imaging technique capable of producing internal images of the core sample without cutting it apart. In some implementations, the image slices 202a-c are produced using a three-dimensional imaging technology, such as, for example CT, FIP-SEM, NMR, and/or another imaging technology. In some cases, the image slices 202a-c are raw imaging data that may be analyzed to produce a three-dimensional model of the core sample. FIG. 2B shows a three-dimensional model 204 constructed by analyzing the set of image slices 200. In some cases, the three-dimensional model 204 may be constructed by layering the image slices on top of one another to produce a full representation of the core sample, and then performing additional analysis on this composite model to identify areas of the model that correspond to rock and areas that correspond to voids. For example,

FIG. 2C is a representation 206 of the computer analysis performed to identify voids 210 in the core sample from the three-dimensional model 204. As shown, the three-dimensional model 204 is analyzed to identify portions of the model representing rock structure (e.g., 208), and portions of the three-dimensional model 204 representing voids 210 in the rock structure 208. In some implementations, the ratio of the voids 210 to the rock structure 208 may be analyzed to produce a porosity value associated with the core sample. The porosity value may be expressed as a fraction of the total volume of the voids 210 to the total volume of the core sample, producing a percentage between 0% (indicating a completely solid core sample) and 100% (indicating a core sample composed entirely of voids). The porosity value may also be expressed in p.u. (porosity units), represented as a number from 0 to 1. In some cases, three-dimensional model 204 may be analyzed to determine an effective porosity of the core sample.

The permeability of the core sample may also be determined by analyzing the three-dimensional model 204. For example, a flow simulation may be conducted on the three-dimensional model using a numerical flow simulation and/or other flow simulation technique to determine the rate at which a fluid will pass through the core sample. In some cases, the flow simulation may take the void space identified in the core sample and the interconnectedness of the void space as inputs and determine a permeability of the core sample from these inputs.

In some implementations, [0001] the three-dimensional model 204 may be imported into a two-scale (e.g. a pore scale to Darcy/continuum scale) wormhole model in a simulation program to predict stimulation patterns associated with an acid treatment. For example, such a simulation may predict that applying a certain type of acid at a certain injection velocity to the rock from which the core sample was taken may produce a wormhole stimulation pattern, while applying a different type of acid a different injection velocity to the rock from which the core sample was taken may produce a ramified stimulation pattern.

FIG. 3 is a representation 300 of examples of different treatment profiles 302a-e. Treatment profile 302a shows an example of the uniform treatment profile, in which large volumes of the rock structure of been eaten away by acid treatment. In some cases, the uniform treatment profile such as 302a may be undesirable because it indicates too much of the rock structure has been removed. Ramified treatment profile 302b shows a similar but less extreme treatment profile in which less of the rock structure has been removed by the treatment than the uniform treatment profile 302a. The treatment profiles 302a and 302b may not be desirable because they indicate that too much of the rock structure has been removed, thus indicating that a less intense treatment may have been sufficient to produce a similar or otherwise suitable flow conductivity.

The wormhole treatment profile 302c may be a desirable treatment profile to achieve. The wormhole treatment profile 302c shows a relatively unitary and continuous flow channel (i.e., wormhole structure) extending through the formation. Such a structure may produce an increase in permeability for the formation, allowing greater conductivity and greater production. Further, the wormhole treatment profile 302c may be desirable because treatments involving removing greater volumes of the rock structure may not produce enough of an increase in formation conductivity to be cost-effective, as they may require the use of more treatment fluid (e.g., acid) or the use of more corrosive treatment fluids. The conical treatment profile 302d and the face treatment profile 302e may be indicative of insufficient rock volume being removed during a treatment, resulting in an unsatisfactory increase in formation conductivity.

In some instances, the treatment profiles in FIG. 3 may be defined according to the following equation:

In one example process for determining acid injection parameters, based on the ratio of transverse to axial length scales of the porous medium dissolved by the acid, the qualitative criteria of acid dissolution shapes is represented in terms of parameter Λ:

$$Λ = \frac{\sqrt{{D}_{eT} {k}_{eff}}}{{u}_{tip}} ,$$

where D_{eT} is the effective transverse dispersion coefficient, uₜᵢₚ is the velocity of the acid fluid at the tip of the wormhole, and k_{eff} is an effective dissolution rate constant defined as

$${k}_{eff} = \frac{1}{( \frac{1}{{k}_{s} {a}_{v}} + \frac{1}{{k}_{c} {a}_{v}} )} = \frac{{k}_{c} {k}_{s}}{{k}_{c} + {k}_{s}} {a}_{v} ,$$

where k_{c} is the pore-scale mass transfer dissolution coefficient, kₛ is the surface reaction dissolution rate constant, aᵥ is the areal fraction (interfacial surface area per unit of volume).

The parameter Λ is used to account for the different acid channel shapes at core-flow conditions:

$$Λ \{ \begin{matrix}≪ O ( 1 ) , & Uniform dissolution , \\ ∈ [ 0.1 , 1 ] , & Wormhole range , \\ ≫ O ( 1 ) , & Face dissolution .\end{matrix}$$

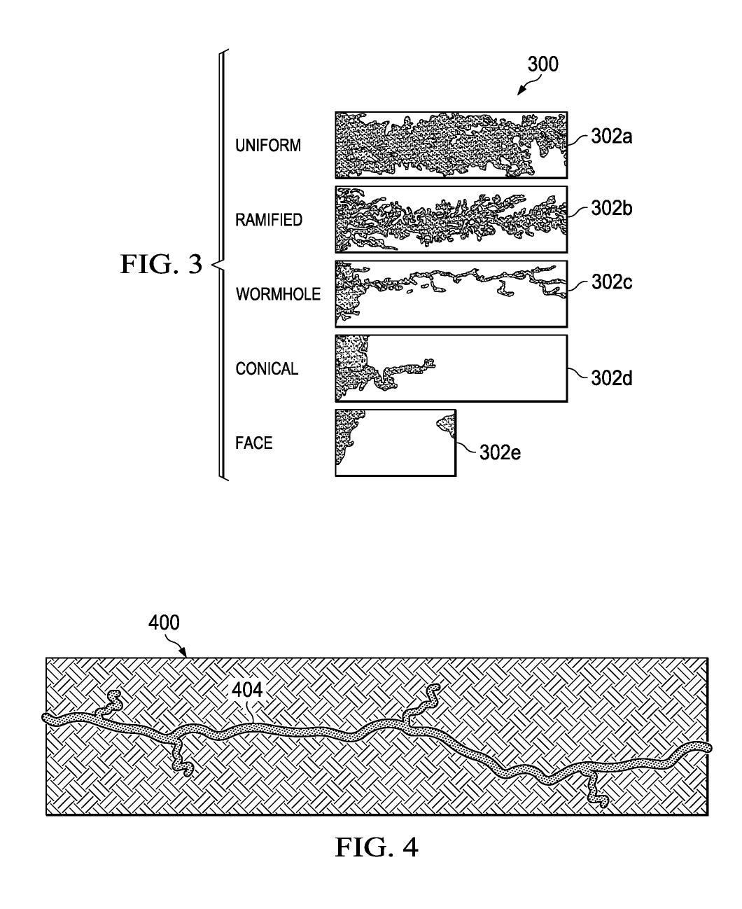

FIG. 4 is a three-dimensional model 400 of a core sample including a wormhole structure 404. The three-dimensional model 400 includes rock structure 402 and a wormhole 404 formed through the rock structure 402. In some implementations, the three-dimensional model 400 may be produced by analyzing a core sample taken from an area for wellbore that has already had an acid treatment applied to it. By analyzing the three-dimensional model 400, a well operator may determine how effective the acid treatment was, and may update a field development plan according to the results. For example, well operator may take one or more cores sample and analyze them using the imaging and three-dimensional modeling techniques described herein. The well operator may then use this analysis to select an acid treatment to perform. After applying the acid treatment, the well operator may take an additional core sample or samples and perform the same analysis on it. By examining the structure produced in the core sample by the acid treatment, the well operator can determine the effectiveness of the acid treatment. The well operator may then use this information to plan or modify treatment parameters of future acid treatments on the same well (e.g. in different locations) or on other wells. How the formation responds to different acid treatments can guide updates to a field development plan. The well operator may take multiple cores before and after treatment for more robust information.

FIG. 5 is a flow chart illustrating an example method for digitally characterizing and simulating wormhole structures in rock.

At 502, a core sample of a rock is imaged to produce a digital core sample model of the structure of the core sample. As previously discussed, the core sample may be imaged according to a three-dimensional imaging technique, including, but not limited to, CT, FIP-SEM, NMR, and/or another technology.

At 504, the core sample model is analyzed to determine the porosity value of the core sample. In some implementations, the porosity value may be expressed in p.u. (porosity units), represented as a number from 0 to 1, or percentage between zero and hundred representing the ratio of solid structure to empty space in the core sample. At 506, the core sample model is analyzed to determine the permeability value of the core sample. In some implementations, the permeability value may be presented in meters squared (m²) or in darcies (D).

At 508, a treatment to perform on the rock is determined, and in certain instances, the treatment is based at least in part on the core sample model. At 510, the treatment is performed on the core sample. At 512, after performing the treatment, the core sample is imaged to produce the final structure of the treated core sample. At 514, the core sample model is analyzed to determine results of the treatment. At 516, a field development plan is updated based on the results of the treatment. Updating the field development plan may include planning or modifying treatment parameters of one or more treatments and/or planning new treatments.

Notably, in certain instances, one or more of the above operations can be performed in a different order and/or omitted. For example, in certain instances, an operator may omit the determination of the permeability, the determination of the porosity, the determination to perform the treatment, collecting and analyzing an additional core samples and/or the operator may omit other steps.

Some embodiments of subject matter and operations described in this specification can be implemented in digital electronic circuitry, or in computer software, firmware, or hardware, including the structures disclosed in this specification and their structural equivalents, or in combinations of one or more of them. Some embodiments of subject matter described in this specification can be implemented as one or more computer programs, i.e., one or more modules of computer program instructions, encoded on computer storage medium for execution by, or to control the operation of, data processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and processors of any kind of digital computer. Generally, a processor will receive instructions and data from a read only memory or a random access memory or both. A computer includes a processor for performing actions in accordance with instructions and one or more memory devices for storing instructions and data. A computer may also include, or be operatively coupled to receive data from or transfer data to, or both, one or more mass storage devices for storing data, e.g., magnetic, magneto optical disks, or optical disks. However, a computer need not have such devices. Devices suitable for storing computer program instructions and data include all forms of non-volatile memory, media and memory devices, including by way of example semiconductor memory devices (e.g., EPROM, EEPROM, flash memory devices, and others), magnetic disks (e.g., internal hard disks, removable disks, and others), magneto optical disks, and CD ROM and DVD-ROM disks. The processor and the memory can be supplemented by, or incorporated in, special purpose logic circuitry.

To provide for interaction with a user, operations can be implemented on a computer having a display device (e.g., a monitor, or another type of display device) for displaying information to the user and a keyboard and a pointing device (e.g., a mouse, a trackball, a tablet, a touch sensitive screen, or another type of pointing device) by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A client and server are generally remote from each other and typically interact through a communication network. Examples of communication networks include a local area network (“LAN”) and a wide area network (“WAN”), an inter-network (e.g., the Internet), a network comprising a satellite link, and peer-to-peer networks (e.g., ad hoc peer-to-peer networks). The relationship of client and server arises by virtue of computer programs running on the respective computers and having a client-server relationship to each other.

In some aspects, some or all of the features described here can be combined or implemented separately in one or more software programs for digitally characterizing and simulating wormhole structures. The software can be implemented as a computer program product, an installed application, a client-server application, an Internet application, or any other suitable type of software

While this specification contains many details, these should not be construed as limitations on the scope of what may be claimed, but rather as descriptions of features specific to particular examples. Certain features that are described in this specification in the context of separate implementations can also be combined. Conversely, various features that are described in the context of a single implementation can also be implemented in multiple embodiments separately or in any suitable subcombination.

A number of embodiments have been described. Nevertheless, it will be understood that various modifications can be made. Accordingly, other embodiments are within the scope of the following claims.

1. A method, comprising:
receiving internal imaging data of a core sample of a rock formation;
generating, by one or more processors of a computing system, a digital core sample model of the structure of the core sample based on the internal imaging data; and
analyzing, by the one or more processors, the core sample model to determine the porosity value of the core sample.

2. The method of claim 1, wherein the internal imaging data is produced using a three-dimensional imaging technique.

3. The method of claim 2, wherein the three-dimensional imaging technique includes at least one of: focused ion beam-scanning electron microscopy (FIB-SEM), computerized tomography (CT), or nuclear magnetic resonance (NMR).

4. The method of claim 1, further comprising analyzing the core sample model to determine the permeability value of the core sample.

5. The method of claim 4, wherein analyzing the core sample model to determine a permeability value of the core sample includes performing a computerized flow simulation using the core sample mode.

6. The method of claim 1, further comprising determining a treatment to perform on the rock formation based at least in part on the core sample model.

7. The method of claim 6, wherein the treatment is an acid treatment.

8. The method of claim 6, further comprising:
performing the treatment on the core sample;
after performing the treatment, imaging the treated core sample to produce an treated core sample model of the structure of the treated core sample; and
analyzing the treated core sample model to determine results of the treatment.

9. The method of claim 8, further comprising updating a field development plan based on the results of the treatment.

10. A system comprising:
memory for storing data; and
one or more processors operable to perform operations comprising:
receiving internal imaging data of a core sample of a rock formation;
generating a digital core sample model of the structure of the core sample based on the internal imaging data; and
analyzing the core sample model to determine the porosity value of the core sample.

11. The system of claim 10, wherein the internal imaging data is produced using a three-dimensional imaging technique.

12. The system of claim 11, wherein the three-dimensional imaging technique includes at least one of: focused ion beam-scanning electron microscopy (FIB-SEM), computerized tomography (CT), or nuclear magnetic resonance (NMR).

13. The system of claim 10, the operations further comprising analyzing the core sample model to determine the permeability value of the core sample.

14. The system of claim 13, wherein analyzing the core sample model to determine a permeability value of the core sample includes performing a computerized flow simulation using the core sample mode.

15. The system of claim 10, the operations further comprising determining a treatment to perform on the rock formation based at least in part on the core sample model.

16. The system of claim 15, wherein the treatment is an acid treatment.

17. The system of claim 15, the operations further comprising:
performing the treatment on the core sample;
after performing the treatment, imaging the treated core sample to produce an treated core sample model of the structure of the treated core sample; and
analyzing the treated core sample model to determine results of the treatment.

18. The system of claim 17, further comprising updating a field development plan based on the results of the treatment.

19. A non-transitory, computer-readable medium storing instructions operable when executed to cause at least one processor to perform operations comprising:
receiving internal imaging data of a core sample of a rock formation;
generating a digital core sample model of the structure of the core sample based on the internal imaging data; and
analyzing the core sample model to determine the porosity value of the core sample.

20. The computer-readable medium of claim 19, wherein the internal imaging data is produced using a three-dimensional imaging technique.
